(19) United States
(12) Patent Application Publication
(10) Pub. No.: US 2003/0193293 A1
(43) Pub. Date: Oct. 16, 2003

(54) Circuit arrangement for operation of incandescent lamps in motor vehicles

(75) Inventors: Gunter Hirschmann, Munchen (DE); Ralf Romberg, Munchen (DE); Christian Wittig, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, Munchen (DE)

(21) Appl. No.: 10/413,471

(22) Filed: Apr. 15, 2003

(30) Foreign Application Priority Data
Apr. 16, 2002 (DE) 102 16 970.5

(51) Int. Cl. B60Q 1/02

(52) U.S. Cl. 315/82

(57) ABSTRACT

Circuit arrangement for operation of incandescent lamps in motor vehicles.

A circuit arrangement for operation of incandescent lamps in motor vehicles, having the following features:

input connections (J1, J2), which are coupled to a vehicle power supply system supply voltage (UB), with the vehicle power supply system supply voltage (UB) essentially being a DC voltage,

output connections (J3, J4), which are coupled to incandescent lamps (Lp),

characterized in that the circuit arrangement contains an inverter which, at the output connections (J3, J4), provides an output voltage (UA) which is essentially an AC voltage.

### TECHNICAL FIELD

The invention relates to the provision of an AC voltage for operation of incandescent lamps in vehicles, with the vehicle having a vehicle power supply system supply voltage which is essentially a DC voltage, and the value of this DC voltage is greater than the value of a rated operating voltage of the incandescent lamps.

### BACKGROUND

A DC voltage with a rated value of 13.2 V is normally used for the vehicle power supply system voltage supply in vehicles. Incandescent lamps that are used in vehicles generally also have the same value or a similar value as the rated operating voltage. However, there are vehicles which have a different value for the vehicle power supply system supply voltage. For example, commercial vehicles in this case have a vehicle power supply system supply voltage of 24 V.

For some time, the automobile industry have been pursuing the aim of increasing the vehicle power supply system voltage supply to 42 V. With regard to the design of halogen incandescent lamps, it has been found, that the normal vehicle power supply system voltage supply of 13.2 V represents a value which can be regarded as being approximately the optimum. Quite apart from logistic reasons, this is a reason why it is intended to retain a rated operating voltage of 13.2 V for the incandescent lamps that are used in vehicles, even in vehicles with a vehicle power supply system supply voltage of 42 V. This accordingly results in the requirement for a converter, to convert the vehicle power supply system voltage supply of 42 V to the rated operating voltage of 13.2 V for the incandescent lamps.

A converter such as this is addressed in the document U.S. Pat. No. 6,340,848 (Maeda). This relates entirely to a DC/DC converter; that is to say the output voltage of this converter is essentially a DC voltage. These are generally so-called step-down converters, which can be used to operate not only incandescent lamps but also other loads, such as electronic control devices or radios.

Pulsed operation is known for operation of incandescent lamps. In this case, an electronic switch is used to cyclically connect an incandescent lamp with a rated operating voltage of 13.2 V to the vehicle power supply system supply voltage of 42 V. This results in the incandescent lamp being operated in a pulsed manner. The lamp is operated with pulses which have a pulsed duration and an amplitude of 42 V. The interval between the pulses governs the period duration of the lamp voltage which is applied to the lamp. The period duration should be sufficiently short that the thermal inertia of the lamp filament means that the filament temperature cannot follow the lamp voltage. The ratio of pulse duration to period duration determines a duty ratio, which allows a root mean square value of the lamp voltage to be set. The period duration may also be varied in order to broaden the spectrum of the lamp voltage.

The described converters which operate in a pulsed manner are characterized by the unipolar nature of the pulses. The lamp voltage can be subdivided into an alternating component and a DC component, with a DC component making up the majority of the lamp voltage. It has been found that operation of incandescent lamps with unipolar pulses has a disadvantageous effect on the life of the lamps. Furthermore, the pulses can cause electromagnetic interference, if no measures are taken to limit the gradient of the pulse flanks.

### DESCLOSURE OF THE INVENTION

One object of the present invention is to provide a circuit arrangement as claimed in the precharacterizing clause of claim 1, which allows incandescent lamps to be operated without any adverse effect on their life.

This object is achieved by a circuit arrangement having the features of the precharacterizing clause of claim 1, by means of the features of the characterizing part of claim 1. Particularly advantageous refinements can be found in the dependent claims.

The vehicle power supply system supply voltage, which essentially represents a DC voltage, is fed into the circuit arrangement according to the invention via input connections. According to the invention, the circuit arrangement contains an inverter, which converts the DC voltage of the vehicle power supply system supply voltage to an AC voltage, which it provides in the form of an output voltage at output connections for the incandescent lamps. The DC component of the output voltage is negligible. This results in the incandescent lamps having a longer life than those which are operated in a pulsed unipolar manner, according to the prior art.

One aspect of the invention is accordingly the bipolar-pulsed operation of the incandescent lamps. By way of example, 4 examples which are known from the relevant literature for the circuitry configuration of the inverter and which can be used in the circuit arrangement according to the invention will be described in the following text: half-bridge inverters, full-bridge inverters, push-pull inverters and forward flyback converters.

Half-bridge inverters require two series-connected electronic switches and at least one coupling capacitor. Incandescent lamps may be connected directly between the junction point of the electronic switches and the coupling capacitor. The root mean square value of the lamp voltage can be set via the duty ratio of the electronic switches. However, it is also possible to couple the incandescent lamps to the half-bridge inverter via a transformer. The root mean square value of the lamp voltage is then also governed by the transformation ratio of the transformer. This allows a duty ratio of 0.5 to be achieved. In consequence, a further aspect of the invention comes into play. The operation of incandescent lamps using an AC voltage allows the vehicle power supply system supply voltage to be matched to the rated operating voltage of incandescent lamps by means of a transformer; with regard to the duty ratio, this results in a degree of freedom which is used to minimize the electromagnetic interference that originates from the circuit arrangement according to the invention. Together with filter devices, this allows an approximately sinusoidal profile of the output voltage to be achieved in a preferred manner for a duty ratio of 0.5, which leads to particularly low electromagnetic interference levels. Parasitic capacitances and inductances, as well as magnetization characteristics of the transformer and coupling capacitors, can be used to provide the filter device.

Full-bridge inverters do not require coupling capacitors, and four electronic switches are required for this purpose, which are subdivided into two series circuits, each having two series-connected electronic switches. Analogously to half-bridge circuits, an incandescent lamp may be connected either directly between the junction points of the two series circuits, or may be coupled to the full-bridge inverter via a transformer. The further statements related to half-bridge inverters also apply in a corresponding manner to full-bridge inverters.

Push-pull inverters require only two electronic switches, and no coupling capacitor, although, on the other hand, a transformer is always required.

Forward flyback converters also always require a transformer, although, in contrast, they require only one electronic switch. The converters may be designed to be resonant or non-resonant.

The choice of the circuit topology for the inverter is in practice governed essentially by the costs. From the technical point of view, the advantages and disadvantages of the three described examples are well known from the relevant literature.

### BRIEF DESCRIPTION OF THE DRAWINGS

The invention will be explained in more detail in the following text using exemplary embodiments and with reference to drawings, in which:

FIG. 1 shows an exemplary embodiment of the invention in the form of a half-bridge inverter,

FIG. 2 shows an exemplary embodiment of the invention in the form of a full-bridge inverter,

FIG. 3 shows an exemplary embodiment of the invention in the form of a push-pull inverter,

FIG. 4 shows an exemplary embodiment of the invention in the form of a forward flyback inverter.

In the following text, transistors are represented by the T, connections by the letter J, inductances by the letter L and capacitors by the letter C, each followed by a number. The same reference symbols are also always used for identical elements, and elements having the same effect, for the various exemplary embodiments in the following text.

### BEST MODE FOR CARRYING OUT THE INVENTION

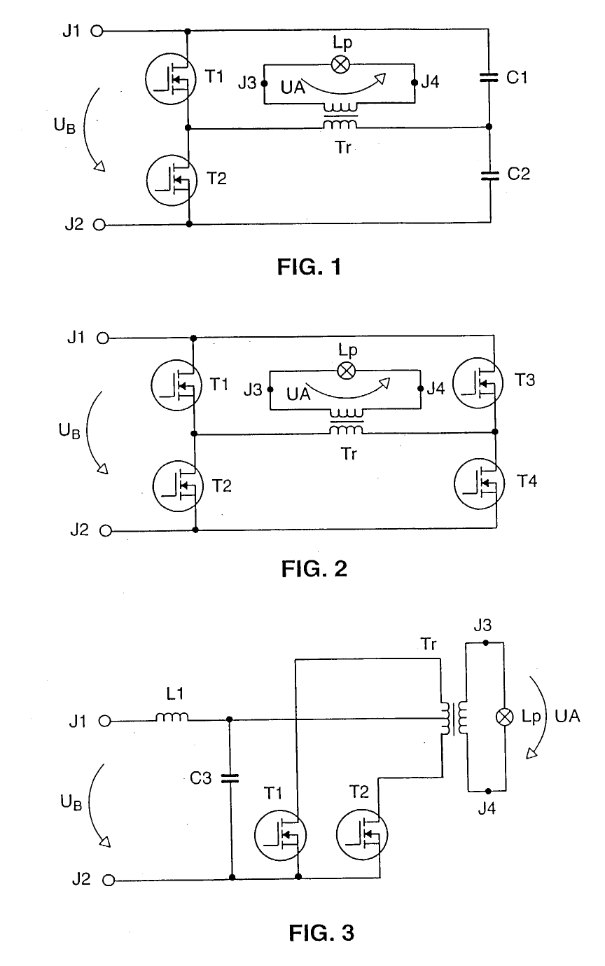

FIG. 1 shows a circuit arrangement according to the invention, in which the inverter is in the form of a half-bridge inverter. The vehicle power supply system supply voltage UB is fed in at input connections J1 and J2. The series circuit formed by two electronic switches T1 and T2, which in the example are in the form of MOSFETs, is connected between J1 and J2. The series circuit formed by two coupling capacitors C1 and C2 is also connected between J1 and J2. The primary winding of a transformer Tr is connected between the junction point of T1 and T2 and the junction point of C1 and C2. The incandescent lamp Lp is connected to the secondary winding of the transformer via output connections J3 and J4. The gate connections of T1 and T2 are connected to pulse generators, which are not illustrated but which switch on the respective transistor for the desired pulse duration.

FIG. 2 shows a circuit arrangement according to the invention, in which the inverter is formed by a full-bridge inverter. The topology corresponds to the topology of FIG. 1 with the difference that the coupling capacitors C1 and C2 from FIG. 1 are replaced by two further electronic switches T3 and T4. The gates of T3 and T4 are also connected to pulse generators, which are not illustrated but which switch on the respective transistor for the desired pulse duration. Normally, T1 is switched on at the same time as T4, and T2 is switched on at the same time as T3. However, the so-called phase-shift mode is also known from the literature, which allows the pulse duration of the pulse which is fed into the transformer Tr to be varied. A mode is also known in which one bridge arm, for example T1 and T2, is clocked at a considerably higher frequency than the other bridge arm.

FIG. 3 shows a circuit arrangement according to the invention, in which the inverter is in the form of a push-pull inverter. In contrast to the examples shown in FIGS. 1 and 2, the push-pull inverter is preceded by a filter device comprising the inductance L1 and the capacitance C3. The vehicle power supply system supply voltage UB is fed into the series circuit formed by L1 and C3 via the input connections J1 and J2. The junction point of L1 and C3 is coupled to a center tap on the primary winding of the transformer Tr. The center tap is coupled to J1 via L1. The ends of the primary winding are each connected to J2 via a respective electronic switch T1, T2. The incandescent lamp Lp is connected to the secondary winding of the transformer Tr via output connections J3 and J4. The gate connections of T1 and T2 are connected to pulse generators, which are not illustrated but switch on the respective transistor for the desired pulse duration.

The resonance frequency of the filter device comprising L1 and C3 can be matched to the frequency at which T1 and T2 are switched. The output voltage is then sinusoidal. An approximately sinusoidal output voltage UA can also be achieved when only L1 is present. In the described example shown in FIG. 3, the filter device is connected upstream of the inverter. It is also feasible for a filter device to be connected downstream from the inverter, for example by means of a capacitance in parallel with the primary or secondary winding.

The examples from FIGS. 1 and 2 may also be equipped with similar filter devices.

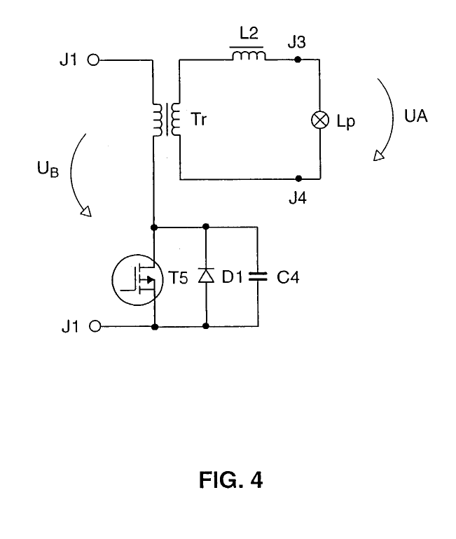

FIG. 4 shows a circuit arrangement according to the invention, in which the inverter is in the form of a forward flyback converter.

The series circuit formed by a primary winding of a transformer Tr and an electronic switch T5 is connected between the connections J1 and J2 between which the vehicle power supply system voltage UB is present. The electronic switch T5 is in the form of a MOSFET. Alternatively, by way of example, a bipolar transistor or an IGBT can also be used. The gate connection of T5 is connected to a pulse generator, which is not illustrated but switches on T5 for the desired pulse duration.

A diode D1 and a capacitor C4 are connected in parallel with the electronic switch T5. The diode D1 is used as a freewheeling diode. It may be omitted if the body diode contained in T5 provides the desired characteristics, for example a rapid backward recovery time.

The series circuit of an inductance L2 and, via the connections J3, J4, a lamp Lp is connected to a secondary winding of the transformer Tr. The output voltage UA is applied to the lamp.

The inductance L2 is matched to the capacitor C4 such that the forward flyback converter operates in a resonant manner. The transformer Tr may thus be configured such that he also carries out the task of the inductance L2.

If the forward flyback converter does not have any resonant operation, the inductance L2 and the capacitor C4 may be omitted.

1. A circuit arrangement for operation of incandescent lamps in motor vehicles, having the following features:
input connections, which are coupled to a vehicle power supply system supply voltage, with the vehicle power supply system supply voltage essentially being a DC voltage,
output connections, which are coupled to incandescent lamps,
characterized in that the circuit arrangement contains an inverter which, at the output connections, provides an output voltage (UA) which is essentially an AC voltage.

2. The circuit arrangement as claimed in claim 1, characterized in that the inverter is in the form of a half-bridge inverter, which is coupled to the vehicle power supply system supply voltage.

3. The circuit arrangement as claimed in claim 1, characterized in that the inverter is in the form of a full-bridge inverter, which is coupled to the vehicle power supply system supply voltage.

4. The circuit arrangement as claimed in claim 1, characterized in that the inverter is in the form of a push-pull inverter, which is coupled to the vehicle power supply system supply voltage.

5. The circuit arrangement as claimed in claim 1, characterized in that the inverter is in the form of a forward flyback converter, which is coupled to the vehicle power supply system supply voltage.

6. The circuit arrangement as claimed in claim 1, characterized in that the inverter contains a transformer, which is coupled to the output connections.

7. The circuit arrangement as claimed in claim 1, characterized in that the vehicle power supply system supply voltage has a value which is between 28 V and 50 V, and the output voltage has a root mean square value which is between 8.8 V and 15.7 V.

8. The circuit arrangement as claimed in claim 1, characterized by the inverter operating in a pulsed manner.
